(19) United States
(12) Patent Application Publication
(10) Pub. No.: US 2007/0053144 A1
(43) Pub. Date: Mar. 8, 2007

(54) Electronics apparatus

(75) Inventors: Masato Nakatani, Kawaguchi-shi (JP); Yuji Nakajima, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/512,495

(22) Filed: Aug. 29, 2006

(30) Foreign Application Priority Data
Aug. 30, 2005 (JP) P2005-249600

(51) Int. Cl. G06F 1/16

(52) U.S. Cl. 361/680; 361/683

(57) ABSTRACT

According to one embodiment, an electronic apparatus comprises: a first case; a display device; and a reinforcement member. The first case comprises; a back wall; a pair of side walls located on opposite side of the back wall; and an upper wall located above the back wall so as to be connected to the pair of side walls. The display device is included in the first case. The reinforcing member is provided inside of the first case. The reinforcing member comprises a first reinforcing portion extending in a widthwise direction of the first case. The first reinforcing portion is fixed to a periphery of the upper wall.

### CROSS-REFERENCE TO RELATED APPLICATION

This application is based upon and claims the benefit of priority from Japanese Patent Application No. 2005-249600 filed on Aug. 30, 2005; the entire contents of which are incorporated herein by reference.

### BACKGROUND

1. Field

One embodiment of the invention relates to an electronic apparatus with a case in which a display device an image is received.

2. Description of the Related Art

An electronic apparatus such as a portable computer includes a computer body provided with a keyboard, and a display unit. The display unit has a liquid crystal panel provided with a screen for displaying an image, and a housing in which the liquid crystal panel is received.

In this type portable computer, there is a demand for increase in size of the screen. As the size of the screen increases, the size of the opening portion increases. Increase in size of the opening portion causes reduction in stiffness of the housing.

Even in the case where the size of the housing per se increases with the advance of increase in size of the screen, the thickness of each of wall portions of the housing shows a tendency toward reduction in order to lighten weight. For this reason, the stiffness of the housing is lowered.

As described above, the stiffness of the housing shows a tendency toward lowering with the advance of increase in size of the screen. Therefore, a reinforcing structure in which reinforcing members are provided along left and right side walls of the housing has been applied to this type electronic apparatus.

In the electronic apparatus such as a portable computer, the display unit is connected to the computer body by hinges so that the display unit can turn between an open position and a close position freely. The close position is a position of the display unit where the keyboard is covered with the display unit from above. The open position is a position of the display unit where the display unit stands up with respect to the computer body.

It is disclosed by JP-A-10-124171, for example, the housing however has the reinforcing members provided along the left and right side walls of the housing. The reinforcing members do not have any sufficient function for suppressing the torsion because the reinforcing members extend in a direction of the height of the housing.

When torsion may act on the case, the torsion acts on the liquid crystal panel received in the case. The liquid crystal panel is distorted. In an electronic apparatus with a large-sized screen, it may be conceived that the influence of torsion increases as described above.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a portable computer is in an open position according to a first embodiment of the invention.

FIG. 2 is an exemplary perspective view showing a state in which the portable computer depicted in FIG. 1 is in a close position.

FIG. 3 is an exemplary exploded perspective view of a display unit depicted in FIG. 1.

FIG. 4 is an exemplary plan view of a display panel depicted in FIG. 3.

FIG. 5 is an exemplary plan view showing an inner surface of a first member of a housing depicted in FIG. 3.

FIG. 6 is an exemplary exploded perspective view of a reinforcing member depicted in FIG. 5.

FIG. 7 is an exemplary sectional view of the display unit in the case where the display unit is cut along a direction from a back wall to a front wall portion of the housing.

FIG. 8 is an exemplary enlarged view of a region F8 shown in FIG. 5.

FIG. 9 is an exemplary enlarged view of a region F9 shown in FIG. 5.

FIG. 10 is an exemplary perspective view showing surroundings of an end portion of a first reinforcing portion and an upper end portion of a second reinforcing member in the range shown in FIG. 9.

FIG. 11 is an exemplary enlarged view of a region F11 shown in FIG. 5.

Fig. 12 is an exemplary enlarged view of a region F12 shown in FIG. 3.

FIG. 13 is an exemplary perspective view showing a first reinforcing member of a portable computer according to a second embodiment of the invention.

FIG. 14 is an exemplary perspective view showing a reinforcing member of a portable computer according to a third embodiment of the invention.

### DETAILED DESCRIPTION

Various embodiments according to the invention will be described hereinafter with reference to the accompanying drawings. In general, according to one embodiment of the invention, an electronic apparatus comprises: a first case, a display device, and a reinforcement member. The first case comprises; a back wall; a pair of side walls located on opposite side of the back wall; and an upper wall located above the back wall so as to be connected to the pair of side walls. The display device is included in the first case. The reinforcing member is provided inside of the first case. The reinforcing member comprises a first reinforcing portion extending in a widthwise direction of the first case. The first reinforcing portion is fixed to a periphery of the upper wall.

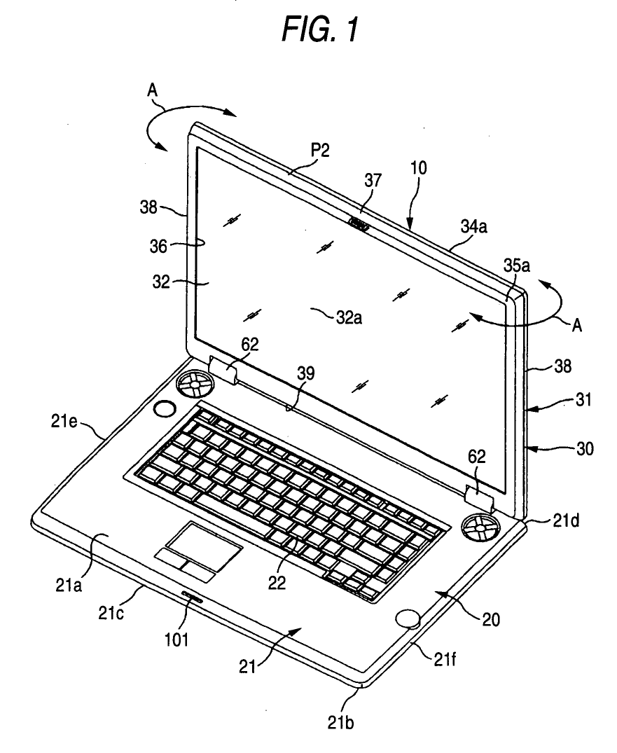

According to an embodiment, FIG. 1 shows the portable computer 10. As exemplary shown in FIG. 1, the portable computer 10 includes a computer body 20, and a display unit 30.

The computer body 20 has a computer housing 21, and a keyboard 22.

The computer housing 21 is shaped like a flat box. The computer housing 21 has an upper wall 21a, a lower wall portion 21b, a front wall portion 21c, a rear wall portion 21d, a left wall portion 21e, and a right wall portion 21f. The keyboard 22 is disposed in the upper wall 21a.

The display unit 30 has a housing 31, and a liquid crystal display panel 32. The housing 31 is shaped like a flat box. The liquid crystal display panel 32 is received in the housing 31.

The housing 31 serves as the first case. The housing 31 is connected to the computer housing 21 through hinges 3 (which will be described later) so that the housing 31 can turn between a close position P1 and an open position P2 freely. The hinges 3 have hinge shafts 60 respectively.

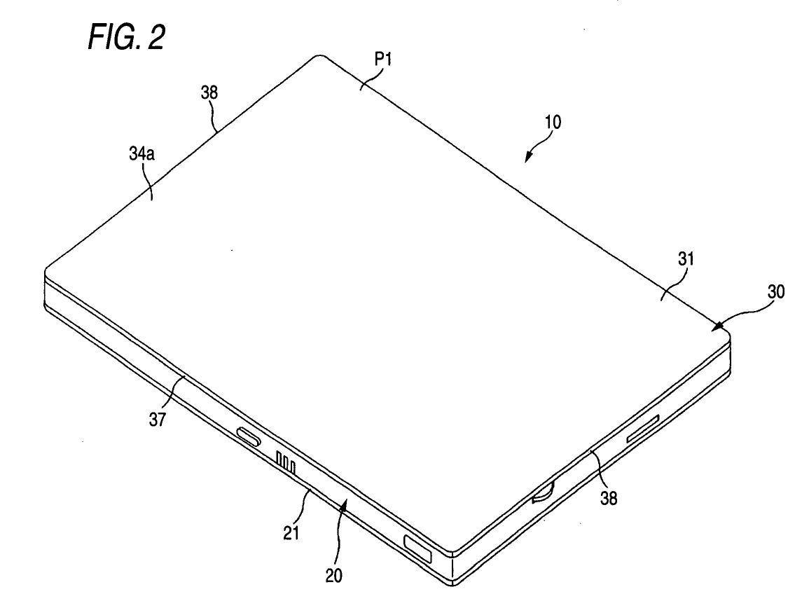

As exemplary shown in FIG. 2, the close position P1 is a position where the display unit 30 is laid on the computer body 20 so that the keyboard 22 is covered with the display unit 30 from above. As exemplary shown in FIG. 1, the open position P2 is a position where the display unit 30 stands up with respect to the computer body 20 so that the keyboard 22 and a screen 32a (which will be described later) are exposed.

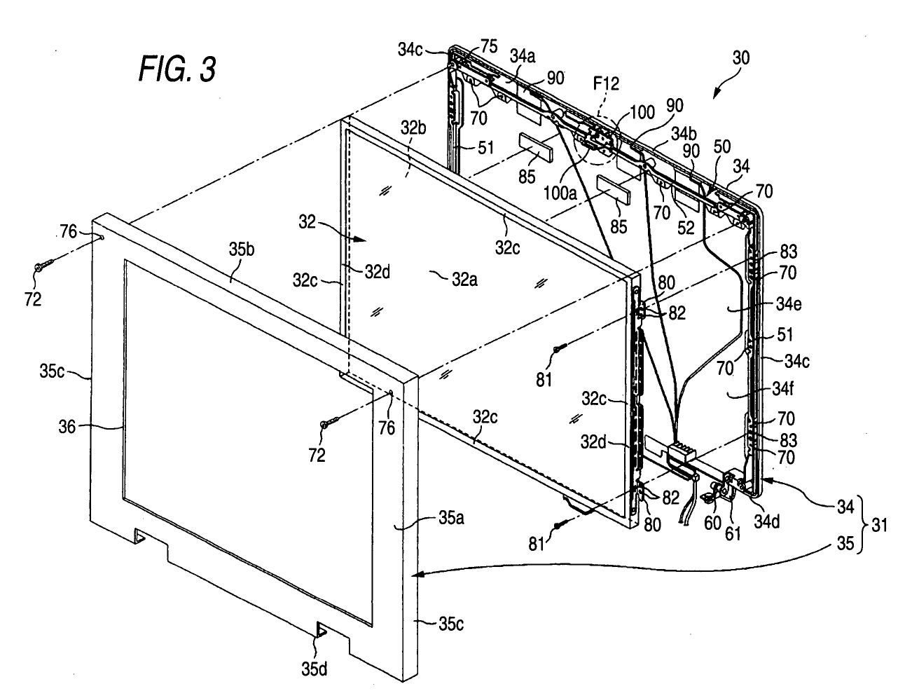

FIG. 3 is an exploded perspective view of the display unit 30. As exemplary shown in FIG. 3, the housing 31 has a first member 34, and a second member 35. The first member 34 forms a back 32b side of the liquid crystal display panel 32 in the housing 31. Incidentally, the back 32b is expressed in a broken line. The second member 35 forms a screen 32a side of the liquid crystal display panel 32 in the housing 31.

The first member 34 has a back wall 34a, a first upper wall 34b, a pair of first side walls 34c, and a first lower wall portion 34d.

The back wall 34a is a wall portion which faces the back 32b of the liquid crystal display panel 32 in the housing 31. Therefore, the back wall 34a is wider than the back 32b of the liquid crystal display panel 32. For example, the liquid crystal display panel 32 is substantially formed like a rectangle shape. Therefore, the back wall 34a is substantially shaped like a rectangle. An inner surface 34e of the back wall 34a is coated with an electrically conductive material so that an electrically conductive layer 34f is provided.

As exemplary shown in FIG. 3, the first upper wall 34b rises from an upper edge of the back wall 34a. The upper edge of the back wall serves as an edge portion which is located upwards when the display unit 30 is in the open position.

One of the first side walls 34c rises from a widthwise end edge of the back wall 34a. The other first side wall 34c rises from the other widthwise end edge of the back wall 34a. The first upper wall 34b is connected to the respective first side walls 34c. The first lower wall portion 34d rises from a lower edge of the back wall 34a. The “lower edge” serves as an edge portion which is located downwards when the display unit 30 is in the open position.

The second member 35 has a front wall portion 35a, a second upper wall 35b, a pair of second side walls 35c, and a second lower wall portion 35d.

The front wall portion 35a faces the screen 32a of the liquid crystal display panel 32 in the housing 31. Therefore, the front wall portion 35a is wider than the liquid crystal display panel 32. The front wall portion 35a is substantially shaped like a rectangle.

An opening portion 36 is formed in the front wall portion 35a. The opening portion 36 pierces the front wall portion 35a. The second upper wall 35b rises from an upper edge of the front wall portion 35a. The second upper wall 35b is connected to the respective second side walls 35c. Incidentally, the “upper edge of the front wall portion 35a” means an edge which is located upwards when the display unit 30 is in the open position.

One of the second side walls 35c rises from a widthwise end edge of the front wall portion 35a. The other second side wall 35c rises from the other widthwise end edge of the front wall portion 35a. The second lower wall portion 35d rises from a lower edge of the front wall portion 35a. The “lower edge” serves as an edge which is located downwards when the display unit 30 is in the open position P2.

As described above, the housing 31 is formed in such a manner that the first and second members 34 and 35 are placed on the top of each other. When the first and second members 34 and 35 are placed on the top of each other, the first upper wall 34b and the second upper wall 35b are connected to each other. When the first upper wall 34b and the second upper wall 35b are connected to each other, an upper wall 37 of the housing 31 is formed.

The first side walls 34c and the second side walls 35c are connected to each other. When the first side walls 34c and the second side walls 35c are connected to each other, side walls 38 of the housing 31 are formed.

The first lower wall portion 34d and the second lower wall portion 35d are connected to each other. When the first lower wall portion 34d and the second lower wall portion 35d are connected to each other, a lower wall portion 39 of the housing 31 is formed.

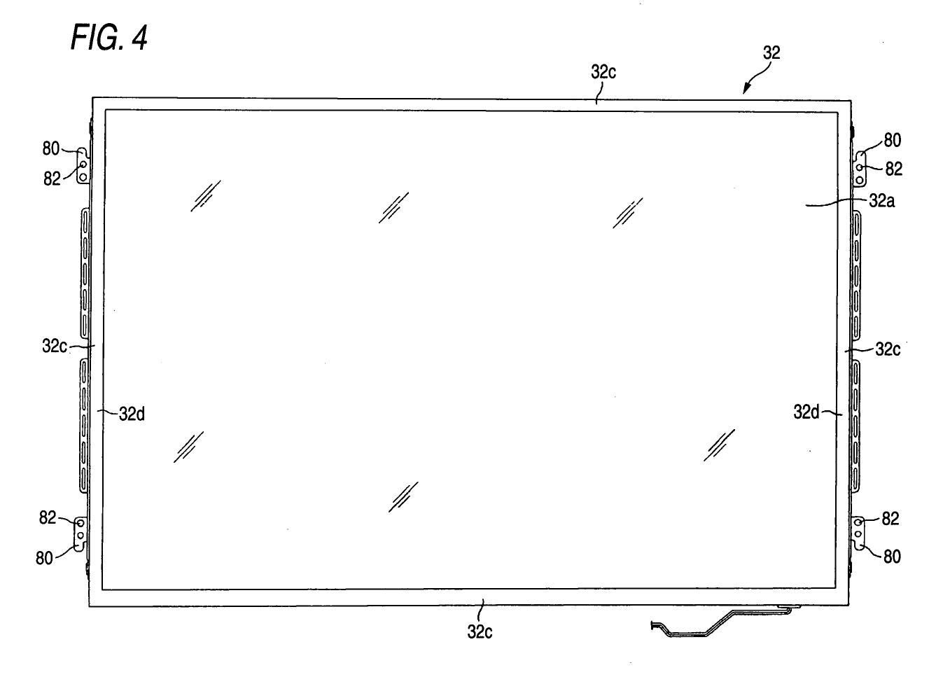

FIG. 4 is an exemplary plan view of the liquid crystal display panel 32. As exemplary shown in FIG. 4, the liquid crystal display panel 32 has the screen 32a for displaying an image. The liquid crystal display panel 32 is an example of the display device. A metal bezel 32c is provided on a circumferential edge portion of the liquid crystal display panel 32. The circumferential edge portion of the liquid crystal display panel 32 is covered with the bezel 32c.

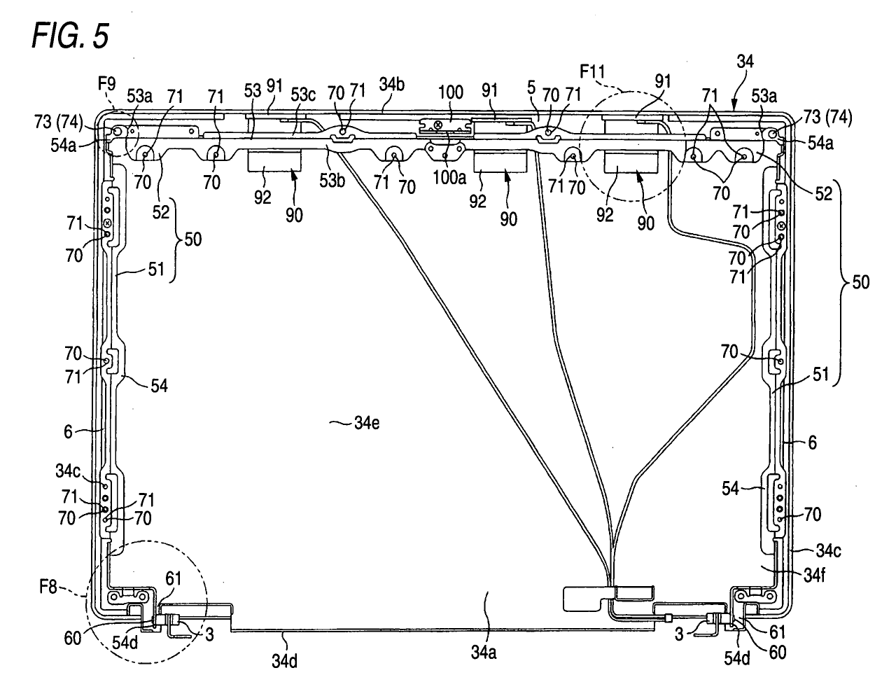

FIG. 5 exemplary shows the inside of the first member 34 of the housing 31. As exemplary shown in FIGS. 3 and 5, the portable computer 10 has a reinforcing member 50 for reinforcing the housing 31.

The reinforcing member 50 has second reinforcing portions 51 extending substantially along the first side walls 34c respectively, and a first reinforcing portion 52 extending substantially along the first upper wall 34b. Therefore, the reinforcing member 50 is substantially U-shaped so as to be opened toward the first lower wall portion 34d. The “height direction” serves as a direction from the upper wall 37 to the lower wall portion 39.

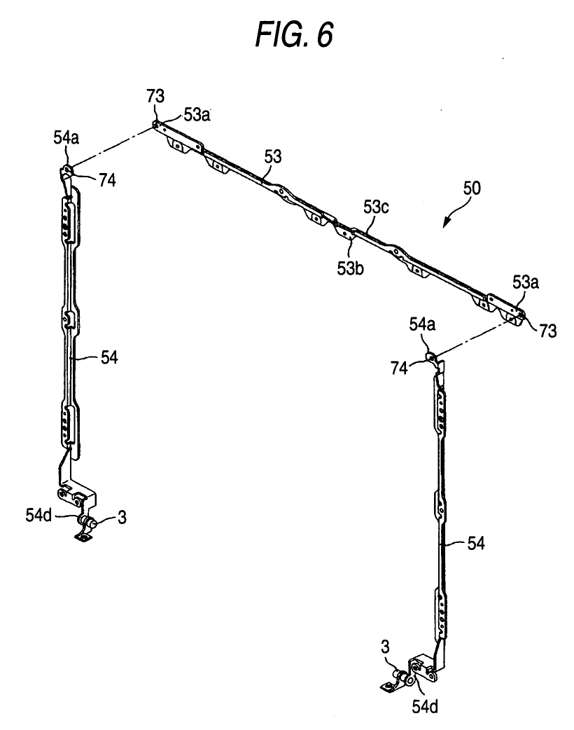

FIG. 6 is an exploded perspective view of the reinforcing assembly 50. As exemplary shown in FIG. 6, the reinforcing member 50 has a first reinforcing member 53, and a pair of second reinforcing members 54. The reinforcing member 50 is formed in such a manner that the first reinforcing member 53 is combined with the second reinforcing members 54 so as to be integrated with the second reinforcing members 54. As exemplary shown in FIGS. 3 and 5, the first reinforcing member 53 and the second reinforcing members 54 are fixed to the housing 31.

The first reinforcing member 53 serves as the first reinforcing portion 52 of the reinforcing member 50 when the first reinforcing member 53 is fixed to the housing 31. The second reinforcing members 54 serve as the second reinforcing portions 51 of the reinforcing member 50 when the second reinforcing members 54 are fixed to the housing 31.

The first reinforcing member 53 has a length substantially equal to the widthwise length of the housing 31. The “widthwise (direction)” is a direction from one side wall 38 to the other side wall 38. The first reinforcing member 53 is fixed to a neighbor of the first upper wall 34a of the first member 34, that is, to an upper edge portion 5 of the housing 31. The first reinforcing member 53 extends substantially in parallel to the first upper wall 34b. Opposite end portions 53a of the first reinforcing member 53 reach widthwise opposite end portions of the first member 34, respectively. The first reinforcing member 53 is made of metal. Incidentally, the “opposite end portions 53a of the first reinforcing member 53” are equivalent to opposite end portions 53a of the first reinforcing portion 52.

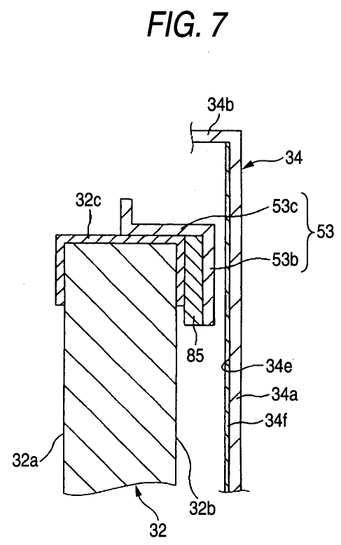

FIG. 7 is exemplary a sectional view of the liquid crystal display panel 32 in the case where the liquid crystal display panel 32 is cut in a direction from the back wall 34ato the front wall portion 35a in a state in which the first reinforcing member 53 is fixed to the back wall 34a. As exemplary shown in FIG. 7, the first reinforcing member 53 has a base portion 53b extending substantially in parallel to the back wall 34a, and a rise portion 53c extending substantially in parallel to the first upper wall 34b. The rise portion 53c rises from an upper edge of the base portion 53b. The base portion 53b is located between the back 32b of the liquid crystal display panel 32 and the back wall 34a of the housing 31.

The first reinforcing member 53 has a structure in which the base portion 53b and the rise portion 53c are provided on the nearly whole region of the first reinforcing member 53. The first reinforcing member 53 is substantially L-shaped in sectional view.

As exemplary shown in FIG. 5, one second reinforcing member 54 is fixed to a neighbor of one first side wall 34c of the first member 34, that is, to one widthwise end edge portion 6 of the housing 31. As exemplary shown in FIG. 3, one second reinforcing member 54, that is, one second reinforcing portion 51, is fixed between one side portion 32d of the liquid crystal display panel 32 and one side wall 38 of the housing 31. One second reinforcing member 54 extends substantially in parallel to one first side wall 34c.

The other second reinforcing member 54 is fixed to a neighbor of the other first side wall 34c of the first member 34, that is, to the other widthwise end edge portion 6 of the housing 31. Specifically, as shown in FIG. 3, the other second reinforcing member 54, that is, the other second reinforcing portion 51, is fixed between the other side portion 32d of the liquid crystal display panel 32 and the other side wall 38 of the housing 31. The other second reinforcing member 54 extends substantially in parallel to the other first side wall 34c. The second reinforcing members 54 are made of metal.

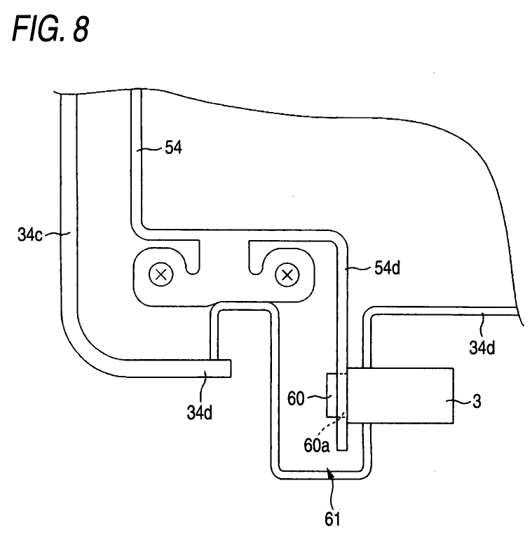

The hinges 3 for connecting the housing 31 and the computer housing 21 to each other will be described. FIG. 8 is an enlarged view of a region F8 shown in FIG. 5. The housing 31 and the computer housing 21 are connected to each other by a pair of hinges 3.

FIG. 8 exemplary shows a surrounding structure of the left hinge 3 shown in FIG. 5. The right hinge 3 shown in FIG. 5 may have the same surrounding structure as that of the left hinge 3 exemplary shown in FIGS. 5 and 8. Therefore, the description of the surrounding structure of the right hinge 3 shown in FIG. 5 will be omitted.

As exemplary shown in FIGS. 5 and 8, a pair of first protrusions 61 are formed in a lower portion of the first member 34 so that the hinges 3 are partially stored in the protrusions 61 respectively. As exemplary shown in FIG. 1, second protrusions 62 are formed in positions of the computer housing 21 corresponding to sides of the first protrusions 61 so that the hinges 3 are partially stored in the second protrusions 62 respectively. Each hinge 3 is stored in corresponding first and second protrusions 61 and 62 while bridged therebetween. Accordingly, the housing 31 and the computer housing 21 are connected to each other by the hinges 3 so that they can rotate freely. The hinge shafts 60 come into the protrusions 61 respectively.

As exemplary shown in FIG. 8, a lower end portion 54d of the second reinforcing member 54 is disposed in the first protrusion 61. A part 60a of the hinge shaft 60 is supported by the lower end portion 54d of the second reinforcing member 54. The second reinforcing member 54 serves also as a support portion for supporting the hinge shaft 60.

A structure in which the reinforcing member 50 is fixed to the housing 31 will be described next.

As exemplary shown in FIGS. 3 and 5, weld pins 70 are provided in a range where the back wall 34a faces the first and second reinforcing members 53 and 54. The weld pins 70 extend from the back wall 34a toward the inside of the housing 31.

Pin through-holes 71 are formed in the first and second reinforcing members 53 and 54 so that the weld pins 70 can pass through the pin through-holes 71 respectively. When the first and second reinforcing members 53 and 54 are disposed in the first member 34, the weld pins 70 pass through the pin through-holes 71 respectively. After passing through the pin through-holes 71, the weld pins 70 are squashed. Accordingly, the first and second reinforcing members 53 and 54 are fixed to the housing 31.

The weld pins 70 serve as positioning portions for positioning the first and second reinforcing members 53 and 54, that is, the first and second reinforcing portions 52 and 51 in the housing 31.

The opposite end portions 53a of the first reinforcing member 53 and the upper end portions 54a of the second reinforcing members 54 are fixed to the first member 34 together with the second member 35 by screws 72. The upper end portions 54a of the second reinforcing members 54 are equivalent to the upper end portions 54a of the second reinforcing portions 51. The screws 72 are an example of the fixing members.

As exemplary shown in FIG. 6, screw through-holes 73 are formed in the opposite end portions 53a of the first reinforcing member 53 so that the screws 72 can pass through the screw through-holes 73 respectively. Through-holes 74 are formed in the upper end portions 54a of the second reinforcing members 54 so that the screws 72 can pass through the through-holes 74 respectively.

A structure using a screw 72 for fixing the left end portion 53a of the first reinforcing member 53, as exemplary shown in FIG. 5, and the upper end portion 54a of the second reinforcing member 54 disposed in the left of FIG. 5 will be described as an example of the fixing structure using the screws 72.

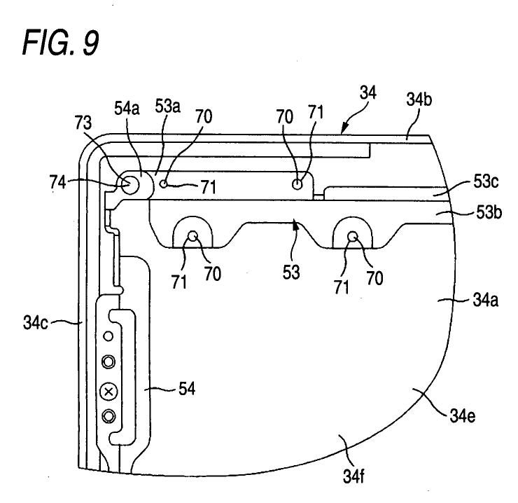

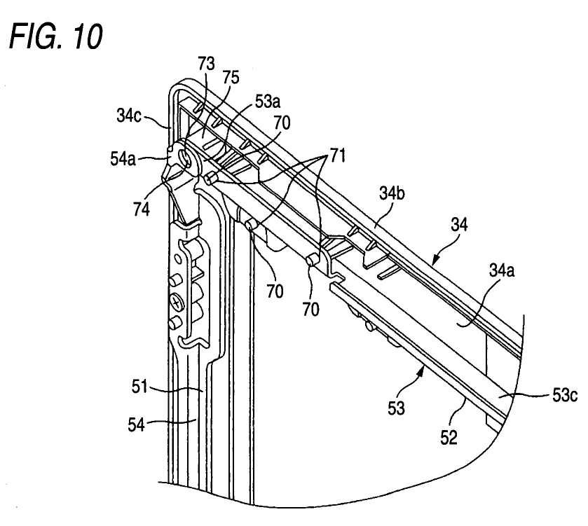

FIG. 9 is an exemplary enlarged view of a region F9 shown in FIG. 5. FIG. 9 exemplary shows the left end portion 53a of the first reinforcing member 53 and the upper end portion 54a of the second reinforcing member 54 disposed in the left of FIG. 5. FIG. 10 is an exemplary perspective view of the surrounding structure of the left end portion 53a of the first reinforcing member 53 and the upper end portion 54a of the second reinforcing member 54 disposed in the left of FIG. 5.

As exemplary shown in FIGS. 9 and 10, the left end portion 53a of the first reinforcing member 53 and the upper end portion 54a of the second reinforcing member 54 disposed in the left of FIG. 5 overlap each other in a direction of the thickness of the housing 31 so that the through-holes 73 and 74 are aligned with each other. Incidentally, the “direction of the thickness of the housing 31” is a direction from the back wall 34a to the front wall portion 35a.

As shown in FIG. 10, the upper end portion 54a of the second reinforcing member 54 is located on the inside of the housing 31, compared with the end portion 53a of the first reinforcing member 53.

A boss portion 75 is formed in each region of the back wall 34a which faces the through-holes 73 and 74. The boss portion 75 protrudes from an inner surface 34e toward the inside of the housing 31. A screw hole is formed in the boss portion 75 so that corresponding one of the screws 72 can engage with the screw hole. The screw hole is aligned with the through-holes 73 and 74.

An electrically conductive layer 34f is provided on a surface of the boss portion 75. The surface of the boss portion and a surface of the back wall 34a are electrically connected to each other.

As exemplary shown in FIG. 3, screw through-holes 76 are formed in positions of the front wall portion 35a of the second member 35 facing the through-holes 73 and 74. The screws 72 pass through the screw through-holes 76 formed in the front wall portion 35a, pass through the screw through-holes 74 formed in the second reinforcing members 54 and pass through the screw through-holes 73 formed in the first reinforcing members 53 so that the screws 72 engage with the screw holes in the boss portions 75 formed on the back wall 34a.

After the screws 72 are fixed, heads of the screws 72 are covered with seal members not shown, or the like. Accordingly, the external appearance of the surface of the front wall portion 35a is restrained from being spoiled by the screws 72.

In the condition that the first and second reinforcing members 53 and 54 are fixed to the housing 31 by the screws 72, the opposite end portions 53a of the first reinforcing member 53 come into contact with the upper end portions 54a of the second reinforcing members 54 respectively. For this reason, the first reinforcing member 53 is electrically connected to the second reinforcing members 54. Moreover, the first reinforcing member 53 comes into contact with the boss portions 75. For this reason, the first reinforcing member 53 and the back wall 34a are electrically connected to each other.

Incidentally, the screw holes formed in the boss portions 75 may be coated with an electrically conductive material. On this occasion, the first reinforcing member 53 and the back wall 34a are electrically connected to each other through the screws 72.

A structure for fixing the liquid crystal display panel 32 to the housing 31 will be described next. As shown in FIG. 4, screw fixing portions 80 are provided in opposite side portions of the liquid crystal display panel 32 so that the screw fixing portions 80 extend circumferentially from the opposite side portions. Specifically, the screw fixing portions 80 are provided so that two screw fixing portions 80 correspond to upper and lower portions in each of the opposite side portions of the liquid crystal display panel 32.

The screw fixing portions 80 are made of metal. For example, the screw fixing portions 80 are electrically connected to the bezel 32c of the liquid crystal display panel 32. Screw through-holes 82 are formed in the screw fixing portions 80 respectively so that screws 81 can pass through the screw through-holes 82.

As exemplary shown in FIGS. 3 and 5, screw through-holes 83 through which the screws 81 can pass are formed in positions of the second reinforcing members 54 facing the screw through-holes 82 of the screw fixing portions 80. For example, boss portions are formed in positions of the back wall 34a facing the screw through-holes 83. Screw holes with which the screws 81 can engage are formed in the boss portions respectively. An electrically conductive layer is provided in a surface of each of the boss portions so as to be electrically connected to the surface of the back wall 34a.

The screws 81 pass through the screw through-holes 82 of the screw fixing portions 80 and pass through the screw through-holes 83 formed in the second reinforcing members 54 so that the screws 81 engage with the screw holes formed in the boss portions of the back wall 34a. On this occasion, the screw fixing portions 80 come into contact with the second reinforcing members 54. For this reason, the respective screw fixing portions are electrically connected to the back wall 34a.

As shown in FIGS. 3 and 7, in the condition that the display unit 30 is fixed to the housing 31, metal plates 85 are sandwiched between the upper portion of the bezel 32c and the first reinforcing member 53. The display unit 30 and the first reinforcing member 53 are electrically connected to each other through the metal plates 85.

As shown in FIG. 5, the portable computer 10 has antenna modules 90. Each antenna module 90 has an antenna portion 91, and a base portion 92. The antenna portion 91 is provided for transmission/reception of a signal, that is, electric wave.

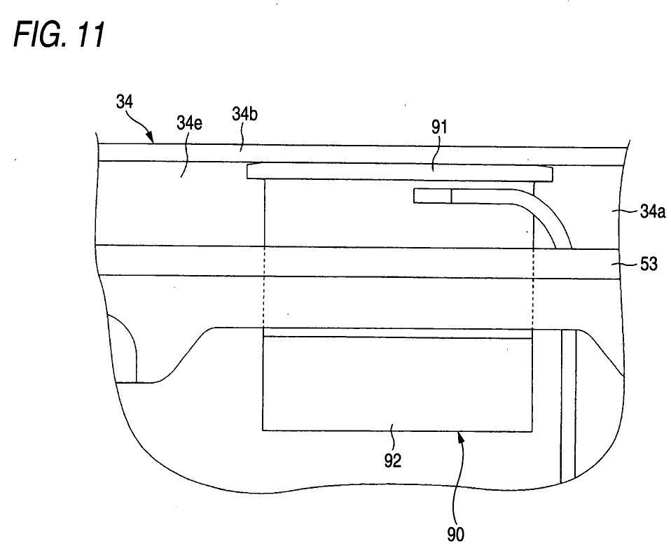

Each antenna module 90 is fixed to a region of the back wall 34a near the first upper wall 34b, that is, each antenna module 90 is fixed to the upper edge 5 of the back wall 34a. The antenna portion 91 is located near the first upper wall 34b, compared with the base portion 92. FIG. 11 is an exemplary enlarged view of a region F11 shown in FIG. 5. As shown in FIG. 11, the antenna portion 91 is located between the first reinforcing member 53 and the first upper wall 34b when the inner surface 34e of the back wall 34a is viewed from above.

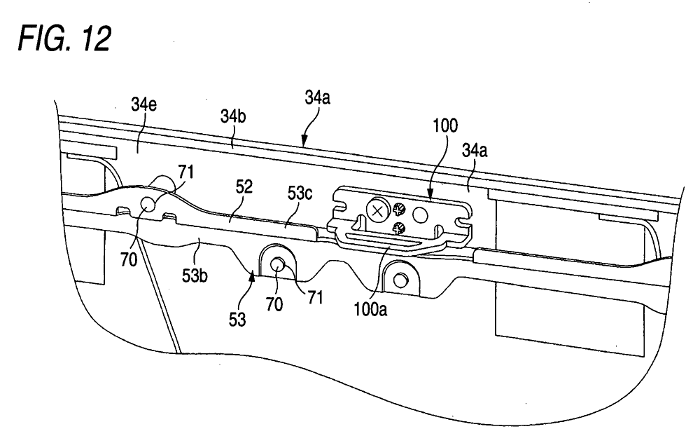

FIG. 12 is an exemplary enlarged view of a region F12 shown in FIG. 3. As exemplary shown in FIGS. 3 and 12, a latch member 100 is fixed to a region of the back wall 34a near the first upper wall 34b. A latch portion 100a is formed at a front end of the latch member 100. When the display unit 30 is in the close position P1, the latch portion 100a engages with a latched portion provided in the computer housing 21. That is, the latch portion 100a engages with the computer housing 21 side. The computer housing 21 is equivalent to the second case. The latch portion 100a is equivalent to the engaging portion.

As exemplary shown in FIG. 1, a slit 101 is formed in the computer housing 21 so that the latch portion 100a can pass through the slit 101. When the latch portion 100a engages with the latched portion, the display unit 30 is kept in the close position P1.

In the portable computer 10 formed as described above, the housing 31 of the display unit 30 has the reinforcing member 50. The reinforcing member 50 has the first reinforcing portion 52. For this reason, the stiffness of the housing 31 is improved.

Accordingly, when, for example, a user of the portable computer 10 turns the display unit 30 between the close position P1 and the open position P2, occurrence of torsion acting on the housing 31 in the widthwise direction as represented by the arrow A in FIG. 1 can be suppressed even if the user grasps the upper edge of the display unit 30.

The reinforcing member 50 further has the pair of second reinforcing members 51. For this reason, the stiffness of the housing 31 is improved more greatly.

The reinforcing member 50 has the first reinforcing member 53 and the pair of second reinforcing members 54 so that the first reinforcing portion 52 is formed from one member while the second reinforcing members 51 are formed from the other members.

For this reason, the reinforcing member 50 can be fixed to the housing 31 when the first reinforcing member 53 and the second reinforcing members 54 are arranged separately in the housing 31. Accordingly, the arranging work can be performed easily. In other words, the reinforcing member 50 can be decomposed so that the arranging work can be made easy.

The opposite end portions 53a of the first reinforcing member 53 and the upper end portions 54a of the second reinforcing members 54 are fixed to the back wall 34a, that is, to the housing 31 by the screws 72. Accordingly, the number of screws 72 for fixing the reinforcing member 50 to the housing 31 can be reduced, so that cost can be reduced. Moreover, mounting density is improved. Moreover, the first member 53 and the second members 54 are tightened collectively, so that the stiffness of the reinforcing member 50 is improved. Moreover, the opposite end portions 53a are fixed to the upper end portions 54a, so that a range surrounded by the reinforcing member 50 can be enlarged. That is, the reinforcing member 50 can satisfy the demand for increase in size of the housing 31.

Because the second reinforcing members 54 support the hinge shafts 60, support parts may not separately support the hinge shafts 60. Accordingly, the number of parts can be reduced.

The first reinforcing member 53, that is, the first reinforcing portion 52, has the base portion 53b, and the rise portion 53c. Therefore, the first reinforcing member 53 is substantially L-shaped in sectional view. Accordingly, the stiffness of the first reinforcing member 53 is improved.

The base portion 53b is located between the back 32b of the liquid crystal display panel 32 and the back wall 34aof the housing 31, so that the first reinforcing portion 52 is located near the liquid crystal display panel 32. Therefore, the liquid crystal display panel 32 is located near a region of the housing 31 little affected by torsion, so that the influence of torsion on the liquid crystal display panel 32 can be suppressed.

Each antenna module 90 is fixed to the housing 31 so that the antenna portion 91 is located between the first reinforcing member 53 and the first upper wall 34b, that is, between the first reinforcing portion 52 and the upper wall 37. That is, transmission/reception of electric wave can be restrained from being disturbed by the first reinforcing portion 52 when the antenna portion 91 is used for transmission/reception of electric wave.

The liquid crystal display panel 32 is electrically connected to the back wall 34a through the metal plates 85, the first reinforcing portion 52 (i.e. the first reinforcing member 53) and the second reinforcing portions 51 (i.e. the second reinforcing members 54). Therefore, the back wall 34a has a ground function.

The weld pins 70 are provided in the back wall 34a. The weld pins 70 serve as positioning portions for positioning the first and second reinforcing members 53 and 54 in the housing 31. Therefore, the work of fixing the first and second reinforcing members 53 and 54 to the housing 31 can be performed easily.

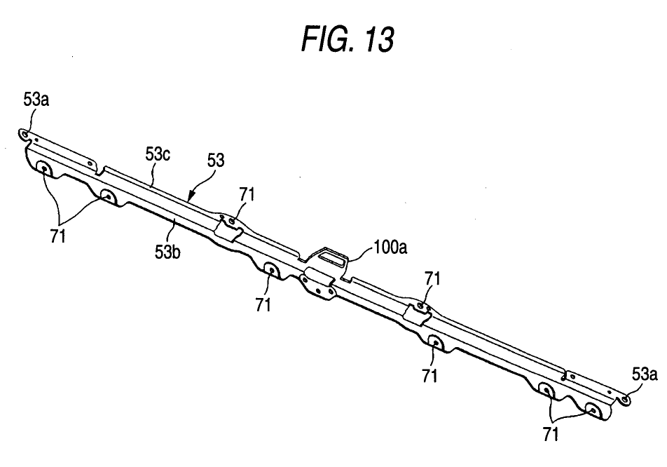

A portable computer 10 as an example of an electronic apparatus according to a second embodiment of the invention will be exemplary described below with reference to FIG. 13. Incidentally, parts functionally the same as those in the first embodiment are referred to by numerals the same as those in the first embodiment for the sake of omission of description.

The embodiment may be the same as the first embodiment except the structure of the first reinforcing member 53. The point of difference will be described specifically.

FIG. 13 exemplary shows the first reinforcing member 53 in this embodiment. As exemplary shown in FIG. 13, the latch portion 100a is formed integrally with the first reinforcing member 53.

In the embodiment, in addition to the effect of the first embodiment, the number of parts can be reduced.

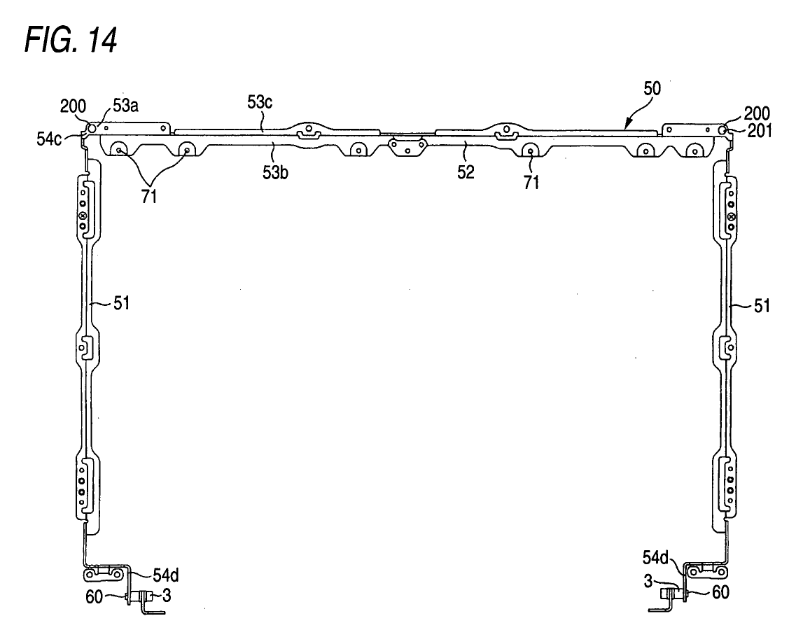

A portable computer 10 as an example of an electronic apparatus according to a third embodiment of the invention will be exemplary described below with reference to FIG. 14. Incidentally, parts functionally the same as those in the first embodiment are referred to by numerals the same as those in the first embodiment for the sake of omission of description.

The embodiment may be the same as the first embodiment except the structure of the reinforcing member 50. The point of difference will be described specifically.

FIG. 14 exemplary shows the reinforcing member 50 in this embodiment. As exemplary shown in FIG. 14, in this embodiment, the first reinforcing portion 52 is formed integrally with the second reinforcing portions 51. In other words, the reinforcing member 50 is formed from one member.

In this embodiment, the opposite end portions 53a of the first reinforcing portion 52 are integrally connected to the upper end portions 54a of the second reinforcing portions 51. Therefore, through-holes 201 through which the screws 72 can pass are formed in connection portions 200 by which these end potions 53a and 54a are integrally connected.

In the third embodiment, in addition to the effect of the first embodiment, the number of parts can be reduced. While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first case comprising;
a back wall;
a pair of side walls located on opposite side of the back wall; and
an upper wall located above the back wall so as to be connected to the pair of side walls;
a display device included in the first case; and
a reinforcing member provided inside of the first case, and the reinforcing member comprising a first reinforcing portion that extends in a widthwise direction of the first case, the first reinforcing portion fixed to a periphery of the upper wall.

2. An electronic apparatus according to claim 1, wherein the reinforcing member comprises a pair of second reinforcing portions, wherein each of the second reinforcing portions is located between a side portion of the display device and the side wall of the first case, and wherein each of the second reinforcing portions is fixed to the firs case.

3. An electronic apparatus according to claim 2, wherein the first reinforcing portion is independently formed from the second reinforcing portions.

4. An electronic apparatus according to claim 3, wherein the first reinforcing portion and the second reinforcing portions are fixed to the first case by a fixing member.

5. An electronic apparatus according to claim 2, further comprising; a second case connected to the first case through a hinge so that the second case can rotate relative to the first case, wherein the second reinforcing portions extend to a lower end portion of the first case, and wherein the second reinforcing portions are supported by a hinge shaft of the hinge.

6. An electronic apparatus according to claim 1, further comprising; a second case connected to the first case through a hinge so that the second case can rotate relative to the first case, wherein an engaging portion is integrally formed with the first reinforcing portion so that the engaging portion engages with the second case when the first case is in a close position where the first case is laid on the second case.

7. An electronic apparatus according to claim 1, wherein the first reinforcing portion comprises; a base portion extending along the back wall; and a rise portion extending along the upper wall and rising from the base portion.

8. An electronic apparatus according to claim 7, wherein the base portion is at least partly located between a back face of the display device and the back wall of the first case.

9. An electronic apparatus according to claim 1, further comprising; an antenna module included in the first case, the antenna comprising an antenna portion located between the first reinforcing portion and the upper wall.

10. An electronic apparatus according to claim 1, wherein the display device and the first reinforcing portion are electrically connected to each other; and the first reinforcing portion and the first case are electrically connected to each other.

11. An electronic apparatus according to claim 2, wherein the first reinforcing portion is integrally formed with the second reinforcing portions.

12. An electronic apparatus according to claim 3, wherein both ends of the first reinforcing portion and upper ends of the second reinforcing portions are fixed to the back wall.

13. An electronic apparatus according to claim 10, wherein the display device and the first reinforcing portion are electrically connected to each other through a metal plate.

14. An electronic apparatus according to claim 10, wherein the back wall of the first case has a ground function.

15. An electronic apparatus according to claim 7, wherein the first reinforcing portion is substantially L-shape, in a cross section.

16. An electronic apparatus according to claim 9, wherein the antenna portion is located between the first reinforcing portion and the upper wall so that transmission/reception of electric wave can be restrained from being disturbed by the first reinforcing portion.
